(19) United States
(12) Patent Application Publication
(10) Pub. No.: US 2009/0213984 A1
(43) Pub. Date: Aug. 27, 2009

(54) Computed Tomography Systems and Related Methods Involving Post-Target Collimation

(75) Inventors: Rodney H. Warner, Austin, TX (US); Royce McKim, Austin, TX (US)

Correspondence Address: O''Shea Getz P.C., 1500 MAIN ST. SUITE 912, SPRINGFIELD, MA, 01115, US

(73) Assignee: UNITED TECHNOLOGIES CORP., Hartford, CT (US)

(21) Appl. No.: 12/037,381

(22) Filed: Feb. 26, 2008

(51) Int. Cl. G01N 23/083; G21K 1/02

(52) U.S. Cl. 378/16; 378/7; 378/147; 378/19

(57) ABSTRACT

Computed tomography (CT) systems and related methods involving post-target collimation are provided are provided. In this regard, a representative method involving post-target collimation of X-rays includes: emitting X-rays toward a target; and collimating the X-rays downstream of the target.

### BACKGROUND

1. Technical Field

The disclosure generally relates to non-destructive inspection of components.

2. Description of the Related Art

Computed tomography (CT) involves the use of X-rays that are passed through a target. Based on the amount of X-ray energy detected at a detector located downstream of the target, information about the target can be calculated. By way of example, representations of target shape and density in three dimensions can be determined.

### SUMMARY

Computed tomography systems and related methods involving post-target collimation are provided. In this regard, an exemplary embodiment of a computed tomography system for use with a target comprises: an X-ray source operative to emit X-rays directed at a target; and a post-target collimator located downstream of the target, the post-target collimator being operative to selectively permit passage of X-rays therethrough.

An exemplary embodiment of a method involving post-target collimation of X-rays comprises: emitting X-rays toward a target; and collimating the X-rays downstream of the target.

Other systems, methods, features and/or advantages of this disclosure will be or may become apparent to one with skill in the art upon examination of the following drawings and detailed description. It is intended that all such additional systems, methods, features and/or advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale. Moreover, in the drawings, like reference numerals designate corresponding parts throughout the several views.

FIG. 1 is a schematic diagram depicting an exemplary embodiment of a system involving post-target collimation.

FIG. 2 is a schematic diagram depicting another exemplary embodiment of a system involving post-target collimation.

FIG. 3 is a flowchart depicting an exemplary embodiment of a method involving post-target collimation.

### DETAILED DESCRIPTION

Computed tomography (CT) systems and related methods involving post-target collimation are provided, several exemplary embodiments of which will be described in detail. In this regard, CT involves passing X-rays through a component and measuring attenuation of the X-rays using a set of detectors. In some embodiments, a post-target collimator is provided that is located downstream of the target and upstream of the detectors. So configured, the post-target collimator tends to reduce the number of unwanted (e.g., scattered) X-rays reaching the detectors that can result in inaccurate measurements of X-ray attenuation.

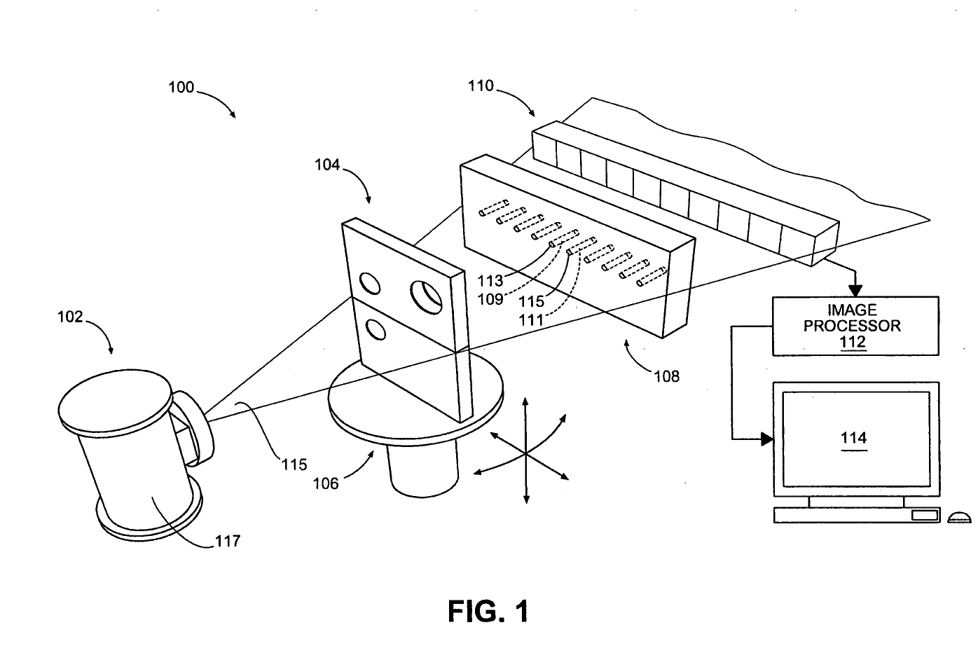

In this regard, FIG. 1 is a schematic diagram depicting an exemplary embodiment of a system involving post-target collimation. As shown in FIG. 1, system 100 includes an X-ray source 102, a target 104 positioned on a turntable 106, a post-target collimator 108, an array of detectors 110, an image processor 112, and a display/analysis system 114. In operation, X-ray source 102 (e.g., a spot source) is operative to emit X-rays. In this embodiment, the X-rays are emitted as a fan-shaped beam 115. Notably, source 102 incorporates an integrated source collimator (not shown in FIG. 1) in order to propagate the fan-shaped beam from a housing 117.

Turntable 106 is a representative apparatus used for positioning a target, in this case, target 104. In operation, turntable 106 is movable to expose various portions of the target to the X-rays emitted by source 102. In this embodiment, turntable can be used to rotate the target both clockwise and counterclockwise, as well as to raise and lower the target. Altering of a vertical position of the target in this embodiment is accomplished to expose different heights (e.g., horizontal planes) of the target to the fan-shaped beam. Notably, the elevation of the beam is fixed in this embodiment.

Post-target collimator 108 is located downstream of target 104 and upstream of detector array 110. Post-target collimator 108 includes an array of channels (e.g., channels 109, 111) through which X-rays can pass. Notably, the channels are located through an intermediate portion of the material forming the post-target collimator so that, as viewed from the X-ray source 102, an array of channel apertures (e.g., apertures 113, 115) positioned at the entrance ends of the channels are presented. Material defining the channels is relatively X-ray absorbing, thereby substantially preventing the passage of X-rays through other than the channels. In the embodiment of FIG. 1, tungsten is used although, in other embodiments, various other materials can be used such as brass or lead, for example.

Detector array 110 is positioned downstream of post-target collimator 108. The detector array is operative to output signals corresponding to an amount of X-rays detected. In this embodiment, the array is a linear array, although various other configurations can be used in other embodiments.

Image processor 112 receives information corresponding to the amount of X-rays detected by the detector array and uses the information to compute image data corresponding to the target. The image data is provided to display/analysis system 114 to enable user interaction with the information acquired by the detector array.

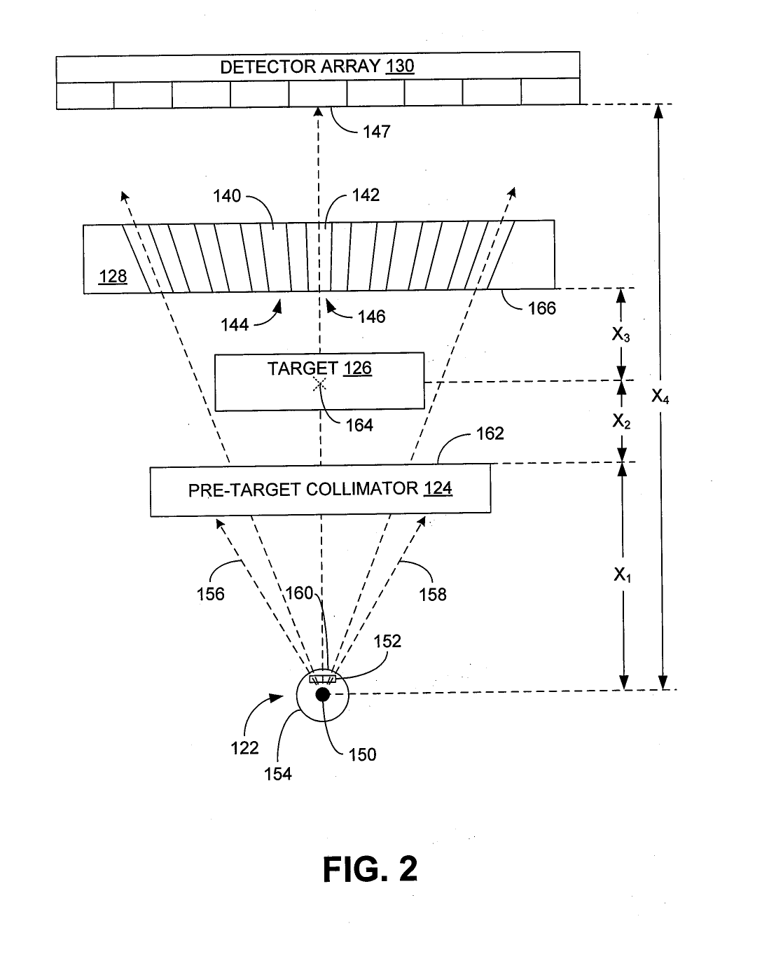

FIG. 2 is a schematic diagram depicting another embodiment of a system involving post-target collimation. As shown in FIG. 2, system 120 includes an X-ray source 122, an optional pre-target collimator 124, a target 126, a post-target collimator 128, an array of detectors 130.

In the embodiment of FIG. 2, post-target collimator 128 includes a fan-shaped array of channels (e.g., channels 140, 142) through which X-rays can pass. Notably, the channels are located through an intermediate portion of the material forming the collimator so that, as viewed from the X-ray source 122, an array of channel apertures (e.g., apertures 144, 146) positioned at the entrance ends of the channels are presented. Material defining the channels is relatively X-ray absorbing, thereby substantially preventing the passage of X-rays through other than the channels.

In the embodiment of FIG. 2, a one-to-one correspondence is exhibited between the number of channels of the post-target collimator and the number of detectors in the array 130. This configuration permits each of the channels to be aligned with a corresponding detector. By way of example, channel 142 is aligned with detector 147. In other embodiments, however, such a one-to-one correspondence and/or alignment need not be provided.

Source 122 is located upstream of the optional pre-target collimator 124, which can be of similar construction to that of the post-target collimator. Source 122 includes an X-ray emitter 150 and an integrated source collimator 152, both of which are positioned within a housing 154. In operation, X-rays emitted from source 122 are directed to the pre-target collimator 124. However, some of these X-rays are prevented from reaching the target, such as edge rays 156, 158, which are directed from the integrated source collimator and out of the housing via an emission surface 160. Downstream of target 126, post-target collimator 128 prevents some of the X-rays (e.g. scattered X-rays) from reaching the array of detectors 130.

One or more of various factors can influence the selection of system parameters, such as relative distances between components. In this regard, these factors can include, but are not limited to: beam fan angle (e.g., 30 degrees); target size (notably, the target should fit entirely within the selected beam fan angle); pre-target collimator thickness (e.g., thickness selected to absorb approximately 90% of the X-rays); post-target collimator thickness (e.g., thickness selected to absorb approximately 90% of the X-rays); and collimator channel spacing (e.g., selected to be a minimum of detector maximum diameter).

A downstream edge 162 of the pre-target collimator 124 is located a distance X₁ from source 150. Additionally, a center of rotation 164 of target 126 is located a distance X₂ from downstream edge 162 of the pre-target collimator, and an upstream edge 166 of the post-target collimator 128 is located a distance X₃ from the center of rotation 164 of target 126. The array of detectors 130 is located a distance X₄ from the source 150.

Noting the above, a target with a maximum diameter of approximately 24 inches (609 mm) should be located at a distance of (X₁+X₂) approximately 46.375 inches (1178 mm) to be positioned within the beam fan. The downstream edge 162 of the pre-target collimator 124 should clear the rotating target. Therefore, edge 162 should be located at a distance (X₁) of approximately 34.375 inches (873 mm). Similarly, the upstream edge 166 of the post-target collimator 128 should be located at a distance (X₁+X₂+X₃) of approximately 58.375 inches (1483 mm).

The minimum thickness for each of the collimators is approximately 0.75 inches (19 mm). Therefore, the front edge of the detectors is located at a distance (X₅) of approximately 60 inches (1524 mm). Notably, this example assumes a readable penetration of approximately 1.5 inches (38 mm) using an X-ray source of approximately 450 K volts. Clearly, various other dimensions can be used in other embodiments.

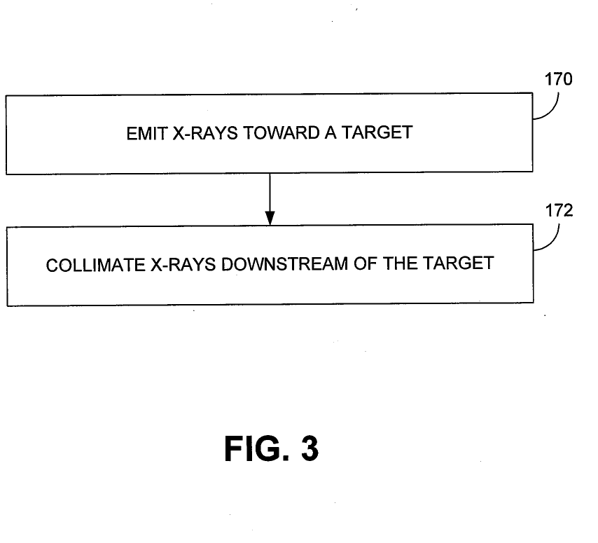

FIG. 3 is a flowchart depicting an exemplary embodiment of a method involving post-target collimation. As shown in FIG. 3, the method may be construed as beginning at block 170, in which X-rays are emitted from a source and directed toward a target. Notably, directing the X-rays at the target can be for the purpose of performing non-destructive inspection of the target using computed tomography to determine one or more of various characteristics. By way of example, the characteristics can include, but are not limited to, interior shape and density of the target. In some embodiments, the target can be a formed of metal. Additionally or alternatively, the target can be a gas turbine engine component, such as a turbine blade.

In some embodiments, the X-rays can be collimated prior to reaching the target. Notably, this can be in addition to collimation that occurs internal to a housing that is used to encase an X-ray emitter.

In block 172, the X-rays are collimated downstream of the target and prior to reaching an array of detectors.

It should be noted that a computing device can be used to implement various functionality, such as that attributable to the image processor 112 and/or display/analysis system 114 depicted in FIG. 1. In terms of hardware architecture, such a computing device can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The processor may be a hardware device for executing software, particularly software stored in memory. The processor can be a custom made or commercially available processor, a central processing unit (CPU), an auxiliary processor among several processors associated with the computing device, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The Input/Output devices that may be coupled to system I/O Interface(s) may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the computing device is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

It should be emphasized that the above-described embodiments are merely possible examples of implementations set forth for a clear understanding of the principles of this disclosure. Many variations and modifications may be made to the above-described embodiments without departing substantially from the spirit and principles of the disclosure. All such modifications and variations are intended to be included herein within the scope of this disclosure and protected by the accompanying claims.

1. A computed tomography system for use with a target comprising:
a housing defining an interior;
an X-ray source located within the interior of the housing and operative to emit X-rays directed at a target; and
an intergrated source collimator located within the interior of the housing; and
a post-target collimator located downstream of the target, the post-target collimator being operative to selectively permit passage of X-rays therethrough.

2. (canceled)

3. (canceled)

4. The system of claim 1, further comprising a pre-target collimator positioned downstream of the housing and upstream of the target, the pre-target collimator being operative to selectively permit passage of scattered X-rays therethrough.

5. The system of claim 1, further comprising an array of X-ray detectors located downstream of the post-target collimator and operative to output signals corresponding to an amount of X-rays detected.

6. The system of claim 5, wherein the post-target collimator has channels formed therethrough, the channels being aligned with the X-ray source to permit passage of X-rays.

7. The system of claim 6, wherein each of the channels is aligned with a corresponding one of the detectors such that the number of channels and the number of detector so aligned exhibit a one-to-one correspondence.

8. The system of claim 5, further comprising an image processor operative to receive information corresponding to the amount of X-rays detected and to provide image data corresponding to a target at which the X-rays are directed.

9. The system of claim 1, wherein the post-target collimator is formed of X-ray absorbing material.

10. The system of claim 9, wherein the X-ray absorbing material is tungsten.

11. The system of claim 1, wherein a spacing between the X-ray source and an upstream edge of the post-target collimator is between approximately 22 and approximately 60 inches.

12. The system of claim 1, wherein a spacing between the target and an upstream edge of the post-target collimator is between approximately 3 and approximately 20 inches.

13. The system of claim 1, wherein the X-ray source exhibits an output of approximately 450 K volts.

14. The system of claim 1, wherein the post-target collimator is operative to absorb at least approximately 90% of the X-rays incident thereon.

15. A method involving post-target collimation of X-rays comprising:
providing a source and an integrated source collimator located within a housing;
emitting X-rays from the source toward a target through the integrated source collimater; and
collimating the X-rays downstream of the target.

16. (canceled)

17. The method of claim 15, wherein the X-rays are directed at the target to perform non-destructive inspection of the target.

18. The method of claim 15, further comprising detecting the amount of X-rays passing through the target.

19. The method of claim 18, wherein:
the collimating of the X-rays downstream of the target is performed by a post-target collimator having channels;
the detecting is performed by detectors located downstream of the post-target collimator; and
the channels and the detectors exhibit one-to-one correspondence.

20. The method of claim 18, wherein the X-rays are used to perform computed tomography of the target.

21. The method of claim 15, wherein the target is a metal component.

22. The method of claim 15, wherein the target is a gas turbine engine component.
